(19) United States
(12) Patent Application Publication
(10) Pub. No.: US 2013/0244505 A1
(43) Pub. Date: Sep. 19, 2013

(54) COMPRESSION TERMINAL FOR STRANDED WIRE AND NON-ELECTRICAL WIRE

(71) Applicant: PPC BROADBAND, INC., East Syracuse, NY (US)

(72) Inventors: BRIAN K. HANSON, East Syracuse, NY (US); NOAH MONTENA, Syracuse, NY (US)

(73) Assignee: PPC BROADBAND, INC., East Syracuse, NY (US)

(21) Appl. No.: 13/832,359

(22) Filed: Mar. 15, 2013

Related U.S. Application Data
(60) Provisional application No. 61/611,060, filed on Mar. 15, 2012.

(51) Int. Cl. H01R 4/10; H01R 43/04

(52) U.S. Cl. CPC H01R 4/10; H01R 43/04
USPC 439/786; 29/505

(57) ABSTRACT

A compression terminal comprising an electrical terminal member, the electrical terminal member configured to receive a stranded wire having a protective outer jacket surrounding a strand bundle, a fastener member including a first inner bore having a first diameter and a second inner bore having a second diameter, the second diameter being less than the first diameter, wherein an internally tapered wall separates the first inner bore from the second inner bore, wherein, when the fastener member is axially slidably compressed from a first position to a second position, the fastener member is configured to compress a portion of the electrical terminal member against the stranded wire is provided. An alternative compression terminal and a wire end termination are further provided. Furthermore, an associated method is also provided.

### CROSS-REFERENCE TO RELATED APPLICATIONS

This application claims the benefit of and priority to U.S. Provisional Application No. 61/611,060, filed on Mar. 15, 2012, entitled “Compression Terminal For Stranded Wire and Non-Electrical Wire.”

### FIELD OF TECHNOLOGY

The following relates to electrical terminals, and more specifically to embodiments of a compression terminal for terminating electrical wire, or non-electrical wire.

### BACKGROUND

When wiring a house, a car, or any other electrical system which relies upon individual conductors to be terminated in a bus bar, or some other type of terminal block, very often the wire must have a terminal crimped to it, especially if the wire is stranded for flexibility reasons. Electrical terminals that require crimping for termination, rarely perform well, largely because it is difficult to evenly crimp them to the wire. Moreover, the wire eventually becomes loose causing intermittent contact between the wire and the terminal. Similarly, a leading edge of non-electrical wires can be difficult to terminate. Current methods of termination for non-electrical cable are done using a knot, swaged thimbles, clamps, barrel and spike, and splicing. These current methods are large and costly, and limit the number of attachments to the non-electrical cable.

Thus, a need exists for an apparatus and method for terminating a wire without the need to crimp the terminal to the wire, while also achieving firm contact between the wire and the terminal.

### SUMMARY

A first general aspect relates to a compression terminal comprising: an electrical terminal member, the electrical terminal member configured to receive a stranded wire having a protective outer jacket surrounding a strand bundle; and a fastener member including a first inner bore having a first diameter and a second inner bore having a second diameter, the second diameter being less than the first diameter, wherein an internally tapered wall separates the first inner bore from the second inner bore; wherein, when the fastener member is axially slidably compressed from a first position to a second position, the fastener member is configured to compress a portion of the electrical terminal member against the stranded wire.

A second general aspect relates to a compression terminal comprising: an electrical terminal member, the electrical terminal member including a post feature configured to receive a stranded wire having a protective outer jacket, a conductive braided layer, and a central dielectric core; an outer body operably attached to the post feature of the electrical terminal member, the outer body having a first end and a second end; and a fastener member including a first inner bore having a first diameter and a second inner bore having a second diameter, the second diameter being less than the first diameter, wherein an internally tapered wall separates the first inner bore from the second inner bore; wherein, when the fastener member is axially slidably compressed from a first position to a second position, the fastener member is configured to compress the second end of the outer body onto the stranded wire.

A third general aspect relates to a method of effectuating compression against a stranded wire in an electrical terminal, such as a compression terminal, including the steps of providing a compression terminal including an electrical terminal member the electrical terminal member configured to receive a stranded wire, and a fastener member including a first inner bore having a first diameter, and a second inner having a second diameter, the second diameter being less than the first diameter wherein an internally tapered wall separates the first inner bore from the second inner bore, and axially compressing the fastener member onto a portion of the electrical terminal member.

A fourth aspect relates generally to a wire end termination comprising: a body member having a first end, a second end, and an inner opening extending axially through the body member, the inner opening starting from the second end an terminating a distance from the first end, wherein the inner opening is configured to receive a non-electrical wire; and a fastener member including a first inner bore having a first diameter and a second inner bore having a second diameter, the second diameter being less than the first diameter, wherein an internally tapered wall separates the first inner bore from the second inner bore; wherein, when the fastener member is axially compressed from a first position to a second position, the second end of the body member is radially compressed onto the non-electrical wire received within the inner opening of the body member.

A fifth aspect relates generally to a wire end termination comprising: a body member having a first end, a second end, the body member comprising: a first body portion having a receiving end proximate the second end of the body member and an inner opening configured to receive a non-electrical wire through the receiving end, and a second body portion having a receiving end proximate the first end of the body member and an inner opening configured to receive the same non-electrical wire through the receiving end; a first fastener member operably attached to the receiving end of the first body portion; and a second fastener member operably attached to the receiving end of the second body portion; wherein, when the first fastener member is axially compressed in a first direction, the receiving end of the first body portion is radially compressed onto the non-electrical wire received within the inner opening of the first body portion; wherein, when the second fastener member is axially compressed in a second direction, the receiving end of the second body portion is radially compressed onto the non-electrical wire received within the inner opening of the first body portion.

A sixth aspect relates generally to a method comprising: providing a body member having a first end, a second end, and an inner opening extending axially through the body member, the inner opening starting from the second end an terminating a distance from the first end, and a fastener member including a first inner bore having a first diameter and a second inner bore having a second diameter, the second diameter being less than the first diameter, wherein an internally tapered wall separates the first inner bore from the second inner bore; positioning the inner opening of the body member over a portion of a non-electrical wire; and axially compressing the fastener member from a first position to a second position to radially compress the second end of the body member onto the non-electrical wire received within the inner opening of the body member.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a cross-sectional view of a first embodiment of a compression terminal having a fastener member, in a first position prior to axial compression;

FIG. 2 depicts a side view of a first embodiment of an electrical wire;

FIG. 3 depicts a cross-sectional view of an embodiment of an electrical terminal member having a post feature;

FIG. 4 depicts a cross-sectional view of an embodiment of an outer body;

FIG. 5 depicts a cross-sectional view of an embodiment of a fastener member;

FIG. 6 depicts a cross-sectional view of the first embodiment of the compression terminal, in a second position, after axial compression of the fastener member;

FIG. 7 depicts a cross-sectional view of an embodiment of a compression terminal having a fastener member, in a first position, prior to axial compression of the fastener member;

FIG. 8 depicts a perspective view of a second embodiment of an electrical wire;

FIG. 9 depicts a cross-sectional view of an embodiment of an electrical terminal member;

FIG. 10 depicts a cross-sectional view of an embodiment of a fastener member used in accordance with the embodiment of a compression terminal;

FIG. 11 depicts a cross-sectional view of the embodiment of the compression terminal, in a second position, after axial compression of the fastener member;

FIG. 12 depicts a plan view of a first embodiment of a non-electrical wire end termination;

FIG. 13 depicts a cross-section view of the first embodiment of a non-electrical wire end termination;

FIG. 14 depicts a plan view of a second embodiment of a non-electrical wire end termination;

FIG. 15 depicts a cross-section view of a second embodiment of a non-electrical wire end termination;

FIG. 16 depicts a plan view of a third embodiment of a non-electrical wire end termination; and

FIG. 17 depicts a cross-section view of a third embodiment of a non-electrical wire end termination.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

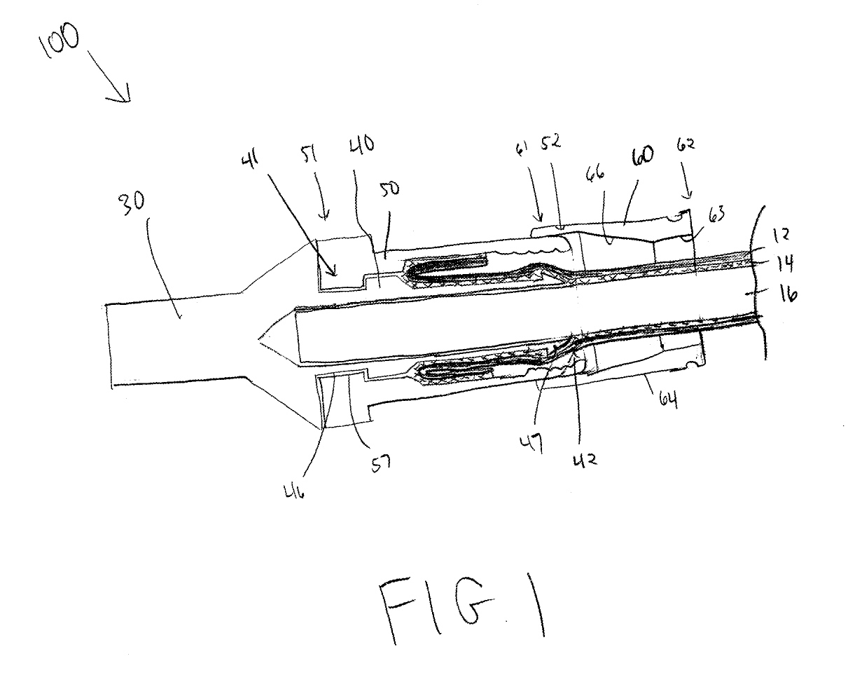

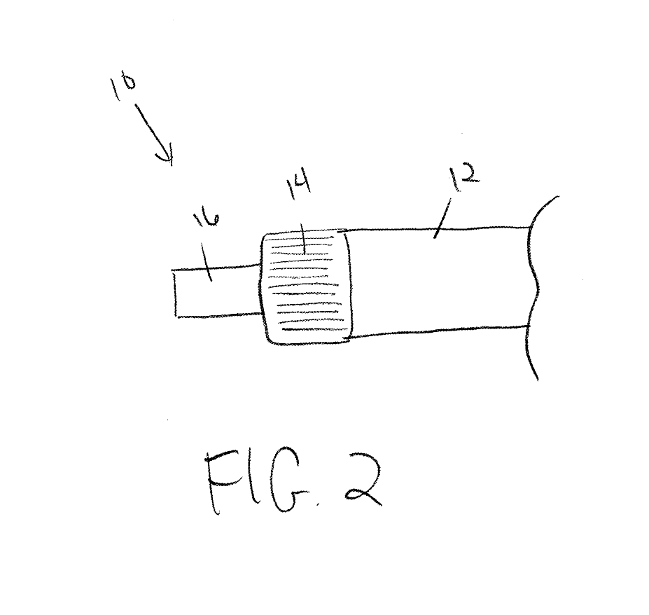

Referring to the drawings, FIG. 1 depicts an embodiment of a compression terminal 100. The compression terminal 100 may terminate, receive, accept, mate, etc., a stranded wire 10 having a protective outer jacket 12, a conductive braided layer 14, and an interior dielectric core 16 (the wire 10 being shown in FIG. 2). The wire 10 may be prepared as embodied in FIG. 2 by removing the protective outer jacket 12 and drawing back the conductive braided layer 14 to expose a portion of the interior dielectric core 16. The preparation of wire 10 may be done with a knife or cable stripping tool. The conductive braided layer 14 may be comprised of conductive materials suitable for providing an electrical connection, such as cuprous braided material, aluminum foils, thin metallic elements, or other like structures. The dielectric core 16 may be comprised of materials suitable for electrical insulation, such as plastic foam material, paper materials, rubber-like polymers, or other functional insulating materials. It should be noted that the various materials of which all the various components of the wire 10 are should have some degree of elasticity allowing the wire 10 to flex or bend in accordance with traditional broadband communication standards, installation methods and/or equipment. It should further be recognized that the radial thickness of the wire 10, protective outer jacket 12, conductive braided shield 14, and interior dielectric core 16 may vary based upon generally recognized parameters corresponding electrical connection standards and/or equipment.

Referring back to FIG. 1, embodiments of compression terminal 100 may include an electrical terminal member 30 having a post feature 40, an outer body 50, and a fastener member 60. The compression terminal 100 may be provided to a user in a preassembled configuration, prior to accepting a wire 10. Embodiments of the compression terminal 100 may be a high amperage compression connector for use in various applications such as automotive, house, public address systems, photovoltaic technology, and the like.

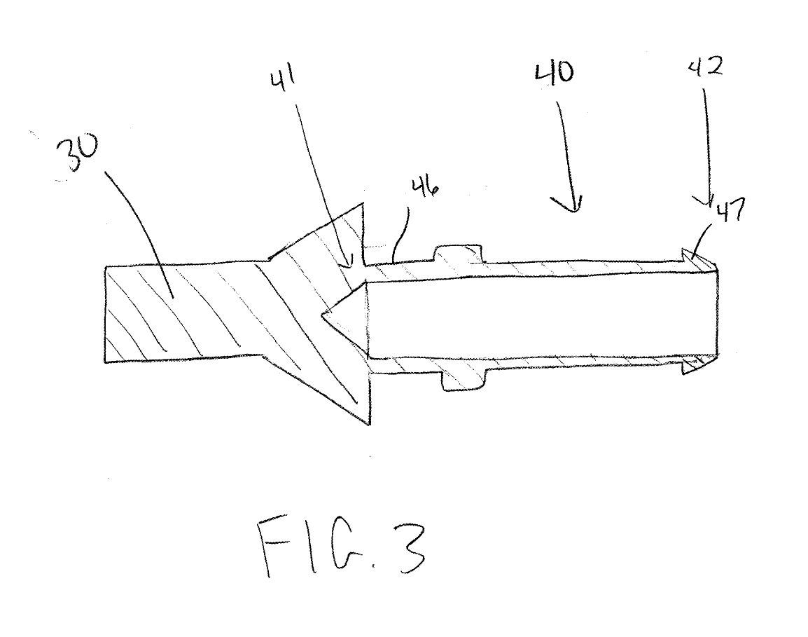

Referring still to FIG. 1, and additional reference to FIG. 3, embodiments of the compression terminal 100 may include an electrical terminal member 30 having a post feature 40. The electrical terminal member 30 may include a metal body. Moreover, the electrical terminal member 30 may be a binding post, banana plug, spade, peg or other conventional electrical terminal. For instance, the electrical terminal member 30 of the compression terminal 100 can have standard shapes for interference with various electrical systems. Embodiments of the electrical terminal 30 may include a post feature 40 configured to receive a wire 10. By providing a post feature 40 to support the braided conductive layer 14, a much greater radial force may be applied to the wire 10 without causing damage, which results in superior mechanical retention and electrical bonding. The post feature 40 may be structurally integral with the electrical terminal member 30. In other words, the post feature 40 may be considered a portion of the electrical terminal member 30. However, it is contemplated that the post feature 40 could be a structurally distinct component from the electrical terminal member 30. The post feature 40 comprises a first end 41 and an opposing second end 42. An annular recess 46 proximate the first end 41 of the post feature 40 accepts a mounting portion 57 of the outer body 50 to help secure axial movement of the outer body 50 with respect to the electrical terminal 30/post feature 40. Embodiments of the post feature 40 may include a generally axial opening beginning from the second end 42 and extending to the first end 41, but ending proximate the electrical terminal member 30, as shown in FIG. 3. Furthermore, the post feature 40 can be formed such that portions of a prepared wire 10 including the dielectric core 16 (examples shown in FIG. 2) may pass axially into the second end 42 and/or through a portion of the tube-like body of the post feature 40. Moreover, the post feature 40 should be dimensioned, or otherwise sized, such that the post feature 40 may be inserted into an end of the prepared wire 10, around the dielectric core 16 and under the protective outer jacket 12 and conductive braided layer 14. Accordingly, where an embodiment of the post feature 40 may be inserted into an end of the wire 10 under the drawn back conductive braided layer 14, substantial physical and/or electrical contact with the braided layer 14 may be accomplished thereby facilitating grounding through the post feature 40. An annular barb 47 may be located proximate the second end 42 of the post feature 40 to facilitate gripping/fastening of the conductive braided layer 14, as well as push the conductive braided layer 14 and the cable jacket 12 radially outward to help form an annular seal around wire 10 when the fastener member 60 is axially compressed to radially compress the second end 52 of the outer body 50 onto the outer jacket 12.

The post feature 40 of the electrical terminal member 30 may be conductive and may be formed of metals or may be formed of other conductive materials that would facilitate a rigidly formed post feature body. In addition, the post feature 40 may be formed of a combination of both conductive and non-conductive materials. For example, a metal coating or layer may be applied to a polymer of other non-conductive material. Manufacture of the electrical terminal member 30 and post feature 40 may include casting, extruding, cutting, turning, drilling, knurling, injection molding, spraying, blow molding, component overmolding, combinations thereof, or other fabrication methods that may provide efficient production of the component.

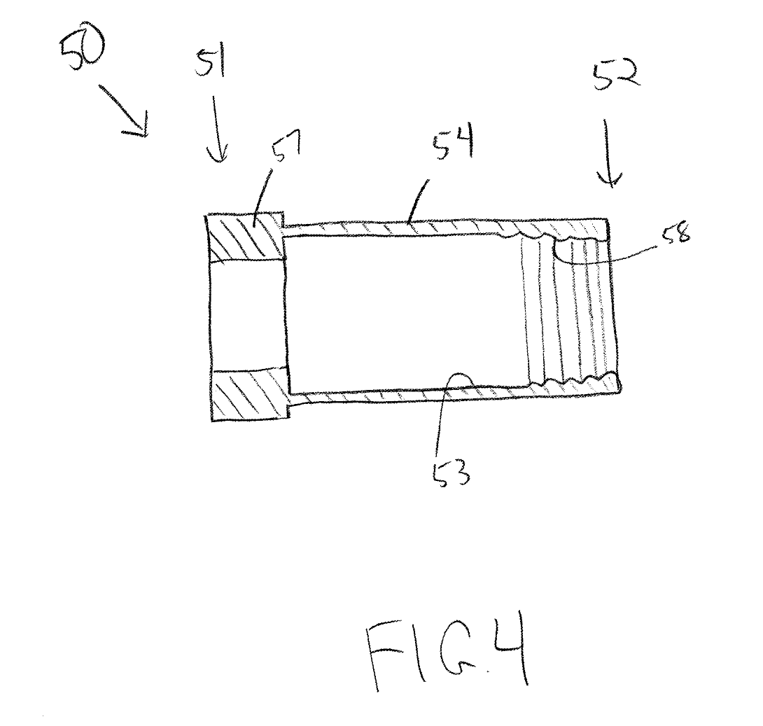

With continued reference to FIG. 1, and additional reference to FIG. 4, embodiments of compression terminal 100 may include an outer body 50. Embodiments of the outer body 50 may be operably attached to the electrical terminal member 30. In an exemplary embodiment, the outer body 50 may be operably attached, or structurally mechanically engaged with, the post feature 40 of the electrical terminal member 30. Embodiments of outer body 50 may include a first end 51, a second end 52, and inner surface 53, and an outer surface 54. Moreover, the outer body 50 may include a mounting portion 57 proximate or otherwise near the first end 51 of the body 50, the mounting portion 57 configured to securely locate the body 50 relative to a portion of the outer surface of post feature 40, so that the outer body 50 is axially secured with respect to the electrical terminal 30 and the post feature 40, in a manner that can prevent the two components from moving with respect to each other in a direction parallel to the axis of the compression terminal 100. The internal surface of the mounting portion 57 may include an engagement feature, such as an annular detent or ridge having a different diameter than the rest of the mounting portion 57. However other features such as grooves, ridges, protrusions, slots, holes, keyways, bumps, nubs, dimples, crests, rims, or other like structural features may be included. Furthermore, the outer body 50 may include a semi-rigid, yet compliant outer surface 54, wherein the outer surface 54 may be configured to form an annular seal when the second end 52 is deformably compressed against a received wire 10 by operation of a fastener member 60. Alternatively, embodiments of the outer body 50 may be metal, and thus the outer surface 54 can be rigid, but still relatively compliant when subjected to radial compression by operation of the fastener member 60.

Moreover, the outer body 50 may include internal surface features 58, such as annular serrations formed near or proximate the internal surface 53 of the second end 52 of the outer body 50 and configured to enhance frictional restraint and gripping of an inserted and received wire 10, through tooth-like interaction with the cable. The outer body 50 may be formed of materials such as plastics, polymers, bendable metals, metals, or composite materials that facilitate a semi-rigid or rigid, yet compliant outer surface 54. Further, the outer body 50 may be formed of conductive or non-conductive materials or a combination thereof. Manufacture of the outer body 50 may include casting, extruding, cutting, turning, drilling, knurling, injection molding, spraying, blow molding, component overmolding, combinations thereof, or other fabrication methods that may provide efficient production of the component.

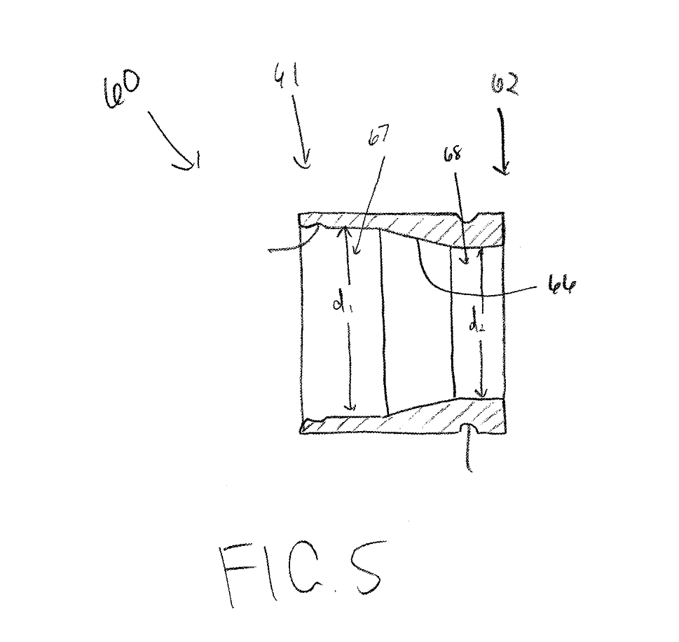

Referring again to FIG. 1, and now also to FIG. 5, embodiments of the compression terminal 100 may include a fastener member 60. Embodiments of the fastener member 60 can be a tubular configuration. The fastener member 60 or compression member can be formed of steel with an electroless nickel/teflon finish, and may have a first inner bore 67 and a second inner bore 68 which together define a central cavity or a central passageway between first end 61 and second end 62 of fastener member 60. For example, the fastener member 60 may include a first inner bore 67 proximate the first end 62 having a first diameter, d₁, and a second inner bore 68 proximate the second end 62 having a second or reduced diameter, d₂, which is less than the diameter of the first inner bore 68, or first diameter, d₁. A ramped surface or inwardly tapered annular wall 66 may separate the first inner bore 67 proximate the first end 62 and the second inner bore 68 proximate the second end 64. The ramped surface 66 may act to deformably compress the outer surface 54 of the outer body 50 when the fastener member 60 is operated to secure a wire 10 within the compression terminal 100. For example, the narrowing geometry can compress squeeze against the wire 10, when the fastener member 60 is compressed into a tight and secured position on the outer body 50. The axial compression of the fastener member 60 may create an environmental seal at the back end of the compression terminal 100. Embodiments of the fastener member 60 may also include a slight flare proximate or otherwise near the first end 61. The fastener member 60 can be coupled to the outer body 50 such that the fastener member 60 can be removed by hand, as shown in FIG. 1, the fastener member 60 is dimensioned and configured relative to the dimensions of the outer body 50 (so that the fastener member 28 is securely attached to the outer body 50). Such attachment can be obtained by a press fit assembly, or may have a snap fit relationship, utilizing a groove and protrusion combination. As described herein, the fastener member 60 can be movably coupled to the outer body 50 so as to be capable of being moved on the outer body 50 from a first preassembled configuration to a second assembled configuration. The fastener member 60 may extend an axial distance so that, when the fastener member 60 is compressed into sealing position on the outer body 50, the first end 61 of the fastener member 60 may reside proximate the first end 51 of the outer body 50. It should be recognized, by those skilled in the requisite art, that the fastener member 60 may be formed of rigid materials such as metals, hard plastics, polymers, composites and the like, and/or combinations thereof. Furthermore, the fastener member 60 may be manufactured via casting, extruding, cutting, turning, drilling, knurling, injection molding, spraying, blow molding, component overmolding, combinations thereof, or other fabrication methods that may provide efficient production of the component.

Further embodiments of the fastener member 60 may include first 61 and second 62 opposing ends and having a central passageway extending therethrough between the first 61 and second 62 ends thereof, the first end 61 of the fastener member 60 having a first non-tapered internal bore 67 of a diameter commensurate with an outer diameter of the outer body 50 for allowing the first end 61 of the fastener member 60 to extend over the second end 52 of the outer body 50, the central passageway of the fastener member 60 including an inwardly tapered annular wall 66 leading from the first internal bore 67 and narrowing to a reduced diameter as compared with the first diameter. The inwardly tapered annular wall 66 may cause the second end 52 of the outer body 50 to be deformed inwardly toward the tubular post feature 40 of the electrical terminal member 30 and against the jacket 12 of the stranded wire 10 as fastener member 60 is advanced axially over outer body 50.

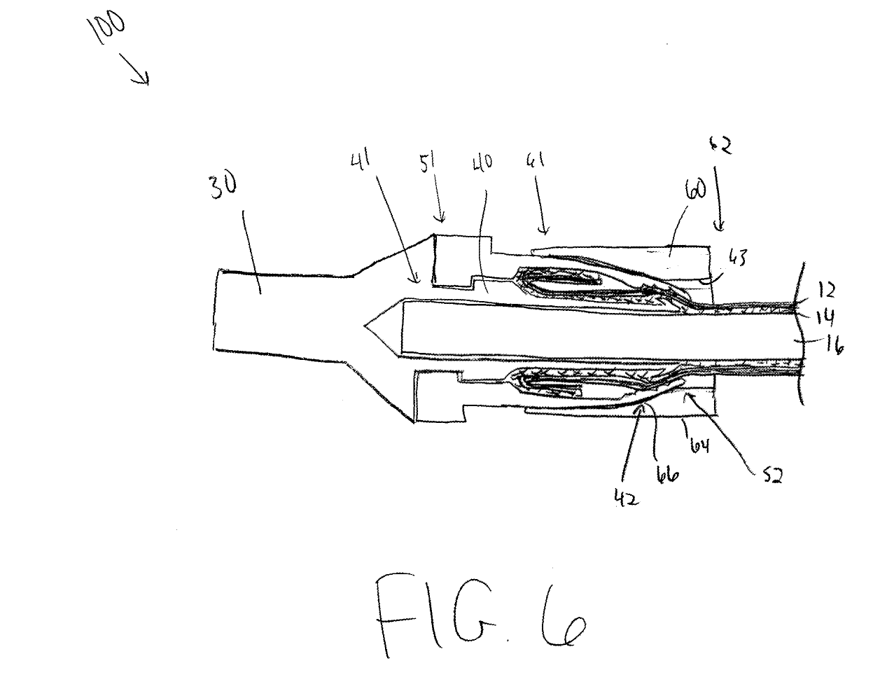

With reference to FIGS. 1-6, the manner in which the compression terminal 100 terminates the wire 10 and forms an annular seal at a back end of the compression terminal 100 will now be described. FIG. 1 depicts a first position, wherein the fastener member 60 has not been axially compressed towards the electrical termination member 30, and over the outer body 50. FIG. 6 depicts a second, compressed position, wherein the fastener member 60 has been axially compressed over and onto the outer body 50 to compress squeeze the second end 52 of the outer body 50 onto the wire 10. Because the second diameter, d₂, of the second inner bore of fastener member 60 is smaller than the outer diameter of the outer body 50 proximate the second end 52 of the outer body 50, the outer body 50 is concentrically gripped so that a volume of the of the internal axial opening of the outer body 50 proximate the second end 52 is further decreased. In other words, the outer body 50 is further displaced or moved radially inwardly. As a result, the protective jacket 12 of wire 10 is firmly gripped or clamped between the outer surface 44 of post feature 40 proximate the second end 42 and the inner surface 53 of the outer body proximate the second end 52. In this manner, the post feature 40 cooperates with the annular serrations, or surface features 58, of the outer body 50 to provide a generally continuous, 360° seal and grip on the outer portion of the wire 10. Advantageously, the operation of the fastener member 60 onto the outer body 50 of the compression terminal 100 can eliminate a need for an O-ring or other seal between the outer body 50 and the fastener member 60, and can accommodate a wide range of wire types and sizes. The operation of the fastener member 60 may also securely fasten the outer body 50, the termination member 30, and the wire. The axial compression of the fastener member 60 can be accomplished with a tool, such a pneumatic or hydraulic compression tool, similar to those used currently for cable television (CATV) compression connectors.

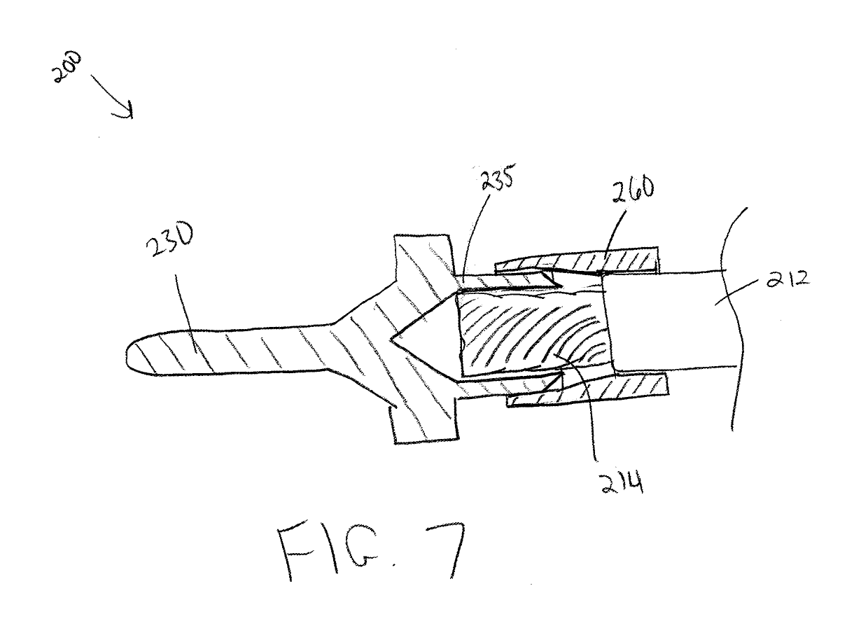

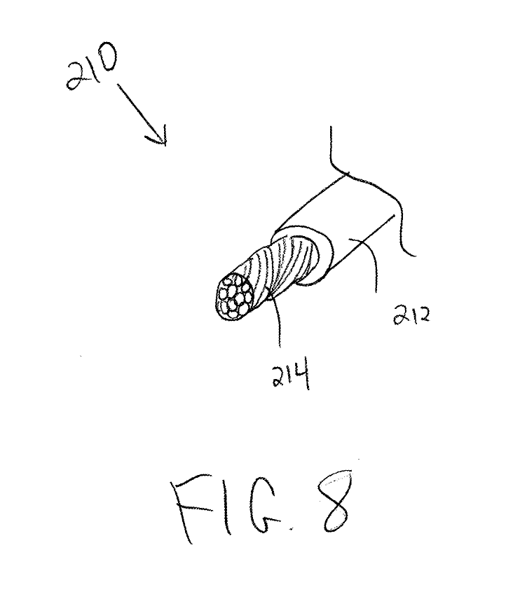

FIG. 7 depicts an embodiment of a compression terminal 200. The compression terminal 200 may terminate, receive, accept, mate, etc., a stranded, single conductor wire 210. The wire 210 may include a protective outer jacket 212 surrounding a strand bundle 214 (the wire 210 being shown in FIG. 8). The wire 210 may be prepared as embodied in FIG. 8 by removing a portion of the protective outer jacket 212 to expose the stranded bundle of wires 214. The preparation of wire 10 may be done with a knife or cable stripping tool. The radial thickness of the wire 210 may vary based upon generally recognized parameters corresponding electrical connection standards and/or equipment.

Referring still to FIG. 7, an embodiment of compression terminal 200 may include an electrical terminal member 230 configured to receive wire 210 and a fastener member 260. The compression terminal 200 may be provided to a user in a preassembled configuration, prior to accepting a wire 210. Embodiments of the compression terminal 200 may be a high amperage compression connector for use in various applications such as automotive, house, public address systems, photovoltaic technology, and the like.

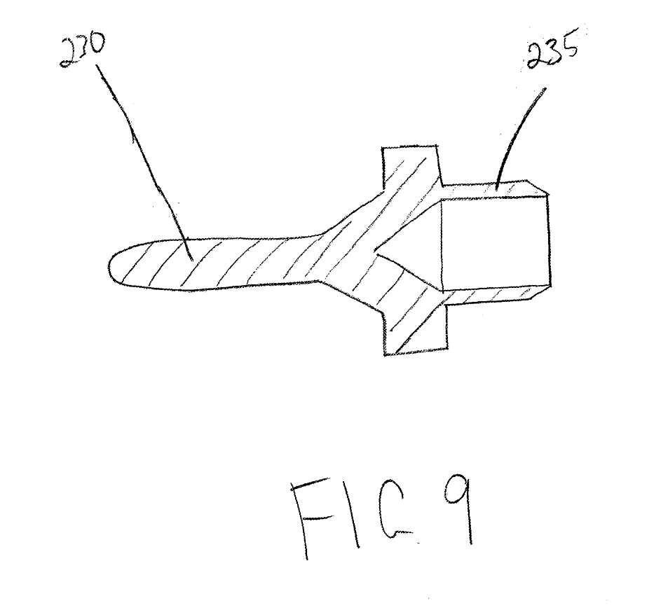

With reference to FIG. 7 and FIG. 9, an embodiment of a compression terminal 200 may include an electrical terminal member 230. The electrical terminal member 230 may be a binding post, a banana plug, a spade, a peg or other conventional electrical terminal. The electrical terminal member 230 of the compression terminal 200 can have standard shapes for interference with various electrical systems. For instance, the electrical terminal member 30 may include a metal body, but may not include a post feature, as associated with electrical terminal member 30. Instead, embodiment of electrical terminal member 230 may include an annular, tubular protrusion 235 extending from the electrical terminal member 230 to receive the stranded bundle 214 of wire 210 and compress uniformly onto the stranded bundle 214 upon axial compression of fastener member 260.

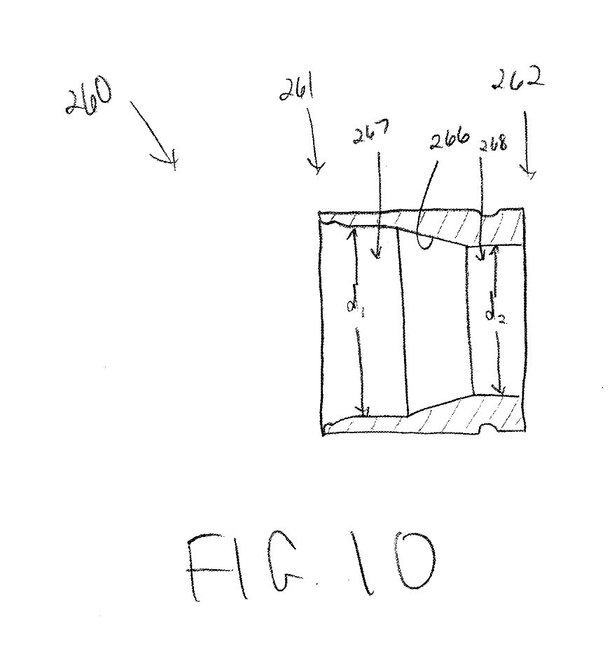

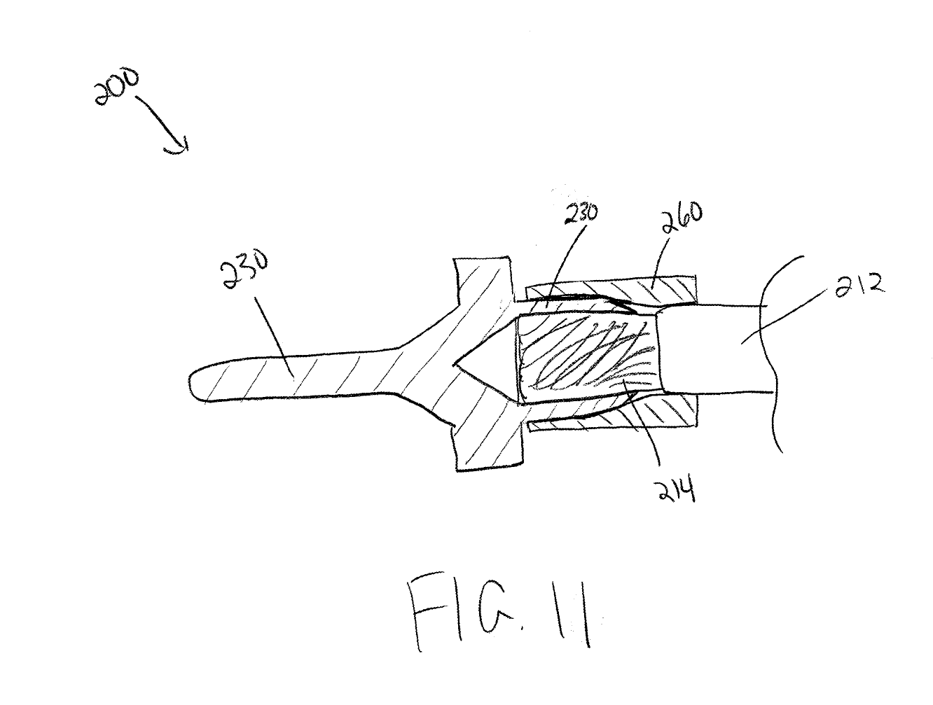

Embodiments of fastener member 260, as shown in FIG. 10, may share the same or substantially the same structural and functional aspects described in association with fastener member 60. For instance, embodiments of fastener member 260 may include a first end 261, a second end 262, and an internal ramped surface 266 creating a taper between the first end 261 and the second end 262. However, fastener member 260 is configured to be axially compressed onto the annular, tubular protrusion 235 which surrounds the stranded bundle 14 of wire 210. Accordingly, the second diameter, d₂, proximate the second end 262, which is smaller than the first diameter, d₁, proximate the first end 262, is smaller than an outer diameter of the annular, tubular protrusion 235 of the electrical terminal member 230. FIG. 7 depicts a first position, wherein the fastener member 260 has not been axially compressed towards the electrical termination member 230, and over the annular, tubular protrusion 235 which accepts the stranded bundle 214 of wire 210. FIG. 11 depicts a second, compressed position, wherein the fastener member 260 has been axially compressed over and onto the annular, tubular protrusion 235 of the electrical terminal member 230 to compress squeeze annular, tubular protrusion 235 onto the wire 210. Because the second diameter, d₂, proximate the second end 262 of fastener member 260 is smaller than the outer diameter of the annular, tubular protrusion 235, the annular, tubular protrusion 235 is concentrically gripped so that the volume of the of the internal axial opening of the annular, tubular protrusion 235 is further decreased. In other words, the annular, tubular protrusion 235 is further displaced or moved radially inwardly. As a result, the bundle 14 of wire 210 (or potentially the protective jacket 212 of wire 210) is firmly gripped or clamped by the inner surface of the annular, tubular protrusion 235 through operation of the fastener member 260.

Further embodiments of the fastener member 260 may include first 261 and second 262 opposing ends and having a central passageway extending therethrough between the first 261 and second 262 ends thereof, the first end 261 of the fastener member 260 having a first non-tapered internal bore 267 of a diameter commensurate with an outer diameter of the annular, tubular protrusion 235 for allowing the first end 261 of the fastener member 260 to extend over the annular, tubular protrusion 235 of the electrical terminal member 230, the central passageway of the fastener member 260 including an inwardly tapered annular wall 266 leading from the first internal bore 267 and narrowing to a reduced diameter as compared with the first diameter. The inwardly tapered annular wall 266 causing the annular, tubular protrusion 235 to be deformed inwardly toward against the bundle 214 (or potentially the bundle 214 and jacket 212) of the stranded wire 210 as fastener member 260 is advanced axially over annular, tubular protrusion 235 of the electrical terminal member 230.

With reference to FIGS. 1-11, a method of effectuating compression against a stranded wire 10, 210 in an electrical terminal, such as compression terminal 100, 200, may include the steps of providing a compression terminal 100, 200 including an electrical terminal member 30, 230, the electrical terminal member 30, 230 configured to receive a stranded wire 10, 210; and a fastener member 60, 260 including a first inner bore 67, 267 having a first diameter, d₁, and a second inner bore 68, 268 having a second diameter, d₂, the second diameter, d₂, being less than the first diameter d₁, wherein an internally tapered wall 66, 266 separates the first inner bore 267 from the second inner bore 268, and axially compressing the fastener member 60, 260 onto a portion of the electrical terminal member 30, 230.

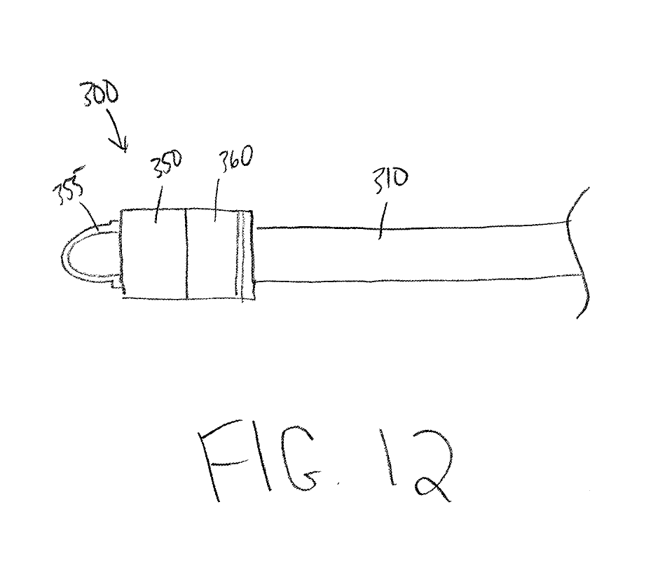

With continued reference to the drawings, FIGS. 12-17 depict embodiments of wire end terminations 300, 400, 401 that may utilize a fastener member 360, 460 to terminate an end of non-electrical wire 310 by radial compression of the fastener member 360, 460. Embodiments of non-electrical wire 310 may include any non-electrical cable or wire, such as rope, braid, string, and the like. Embodiments of fastener member 360, 460 may share the same or substantially the same structural and functional aspects of fastener member 60, 260, described in association with compression terminal 100, 200. However, fastener member 360, 460 may compress one or more non-electrical cables 310 together to terminate the non-electrical cable 310 at various locations. Embodiments of non-electric wire 310 may include cable, non-electrical cable, wire, wire rope, such as steel or iron wire rope, traditional rope made of natural materials, plastic rope, and the like. The fastener member 360, 460 may also include an integrated thimble.

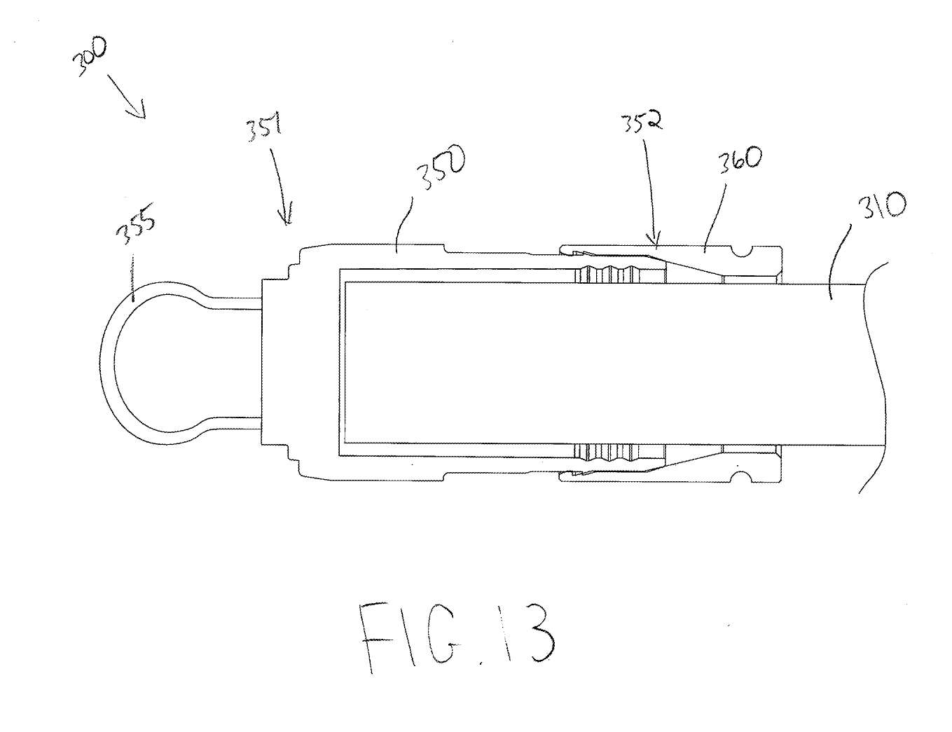

FIGS. 12 and 13 depict an embodiment of a wire end termination 300. Embodiments of wire end termination 300 may include a fastener member 360 and a body member 350. Embodiments of the body member 350 may have a first end 351 and a second end 352, wherein an attachment device 355 may be operably connected to the body member 350 proximate or otherwise near the first end 351 of the body 350. Embodiments of the attachment device 355 may be one or more hooks, clips, ring, eyelets, straps, loops, bended loop, bended hook, prepared loops, thimble eyes, carabineers, and the like. In one embodiment, the attachment device 355 may be structurally integral with the body member 350. In another embodiment, the attachment device 355 may be a separate, physical structure that is attached, glued, fastened, or otherwise mechanically attached to the body member 350. Embodiments of the body member 350 may have a generally annular opening starting from the second end 352 and extending through the body member 350 a distance towards the first end 351. In other words, the body member 350 may have an inner bore through the body member 350. The inner bore, or opening, may be configured to receive an end of non-electrical wire 310 for termination. For example, the non-electrical wire 310 may enter the inner opening of the body member 350 from the second end 352 as the body member 350 is slid over the wire 310; the wire 310 may extend until as far as necessary within the inner bore of the body member 350. In an exemplary embodiment, the fastener member 360 may already be attached to the body member 350 prior to sliding over the wire 310. For instance, embodiments of the wire end termination 300 may come in a pre-assembled configured to the consumer, wherein the fastener member 360 is attached to the body member 350, similar to the first, uncompressed position described supra.

Once the wire 310 has passed through the opening of the fastener member 360 and entered the inner opening of the body member 350, a user may axially compress the fastener member 360 to radially compress the second end 352 of the body member 350 onto the wire 310, which can securely fasten the wire 310 to the body member 350. Accordingly, an end of the wire 310 can be terminated by the wire end termination 300 with various attachment devices.

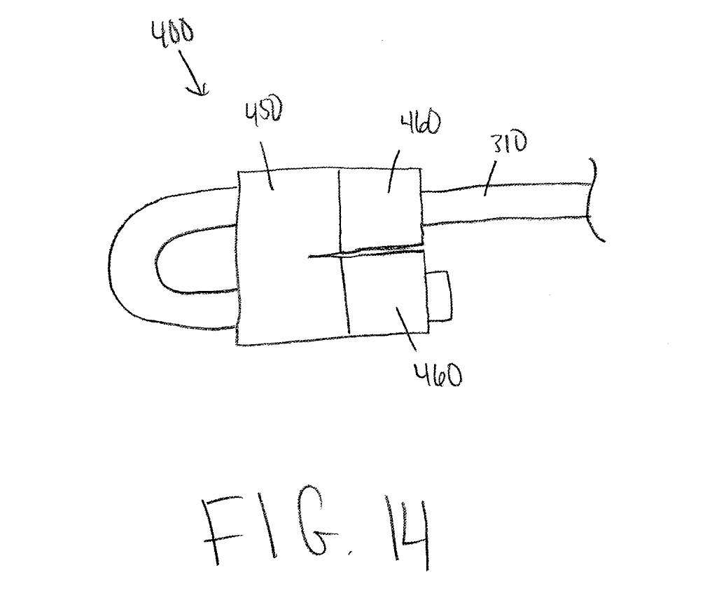

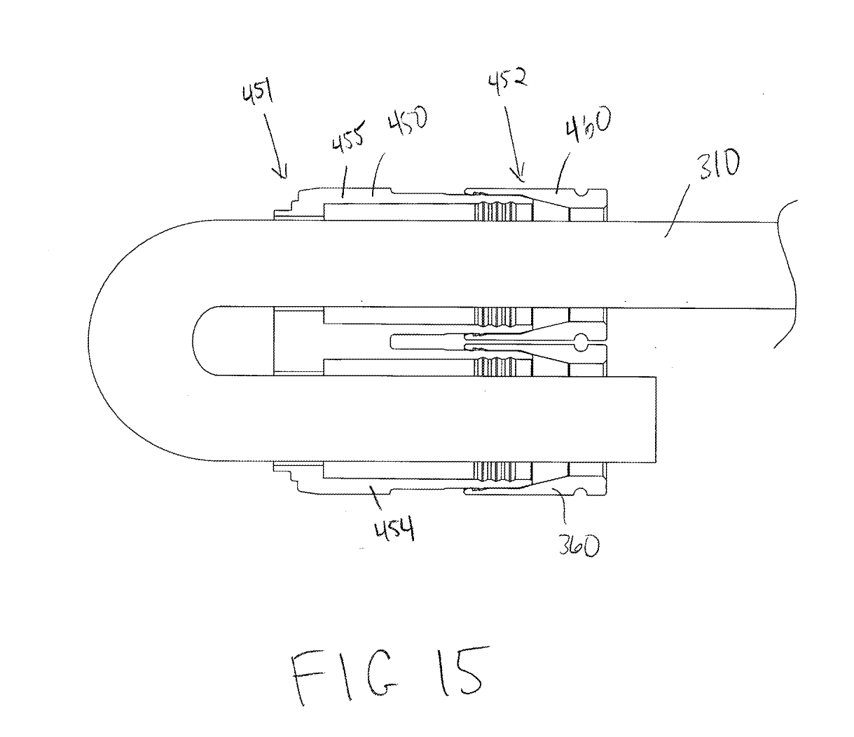

FIGS. 14-15 depict an embodiment of a wire end termination 400. Embodiments of wire end termination 400 may include a fastener member 460 and a body member 450. Embodiments of the body member 450 may have a first end 451 and a second end 452. Embodiments of the body member 450 may include a first body portion 455 and a second body portion 455, wherein each body portion 454, 455 can include an inner bore or opening for receiving the non-electrical wire 310. For instance, the first body portion 455 and the second body may each have a generally annular opening starting from the second end 452 and extending a distance through the first end 451. In other words, the body member 450 may have more than one inner bore through the body member 450. The inner bore, or opening, may be configured to receive an end of non-electrical wire 310 for termination; the end of the body portion 455, 454 where the wire 310 enters the inner opening may be referred to as a receiving end. The receiving end may be either proximate the first 451 or the second end 451 of the body member 450 for each of the first body portion 455 and the second body portion 455. However, in an embodiment where the receiving ends are proximate opposing ends of the body member 450, the wire 310 may form a loop or other closed configuration, as shown in FIG. 15. For example, the non-electrical wire 310 may enter the inner opening of the first body portion 455 of the body member 450 from the second end 352 as the body member 350 is slid over the wire 310; the wire 310 may pass through the inner bore of the first body portion 455 of body member 450, and then loop back to enter the inner bore of the second body portion 454 of body member 450. In an exemplary embodiment, a fastener member 460 may already be attached to the ends of the first body portion 455 and the second body portion 454 of the body member 450 prior to sliding over the wire 310. For instance, embodiments of the wire end termination 400 may come in a pre-assembled configured to the consumer, wherein the fastener members 460 are attached to the body member 450, similar to the first, uncompressed position described supra. FIG. 15 depicts multiple fastener members 460 attached to a single body member 450 in a direction that compression of each of the fastener members 460 would be in the same direction. Embodiments of wire end termination 400 may include fastener members 460 attached to the body member 450 such that the direction of axial compression of one of the fastener members 460 would be an opposing or different axial direction. Further, while embodiments of the fastener member 460 are showed as a first and second, separate fastener member attached to the receiving ends of the body portions 455, 454, embodiments of the fastener 460 could be a single component, wherein the fastener member 460 is a one-piece component having two or more internal bores for receiving the first and second body portions 455, 454. In this embodiment, a user may be able to fasten the wire 310 with a single compressive motion driving the one-piece fastener member 460 over the body member 450.

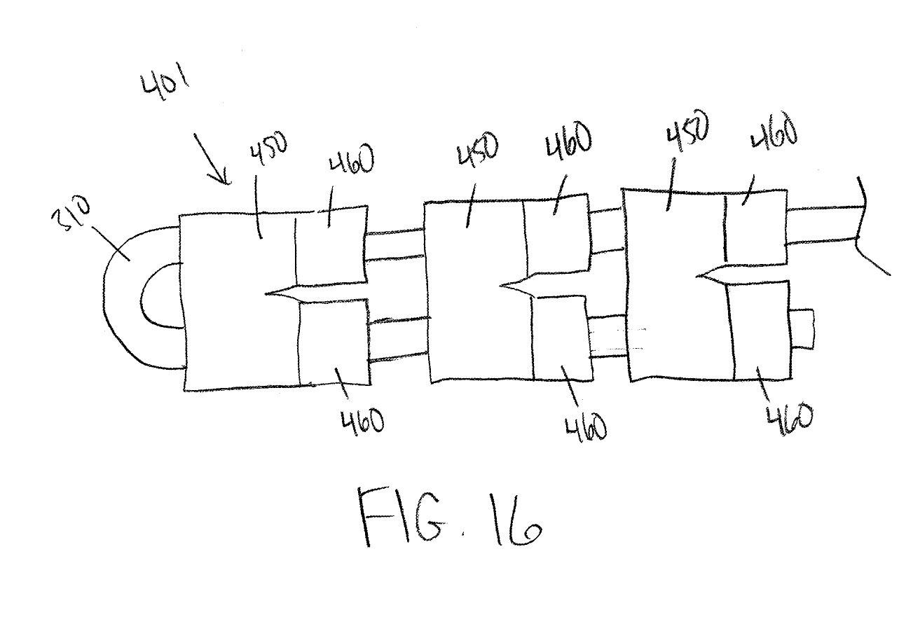

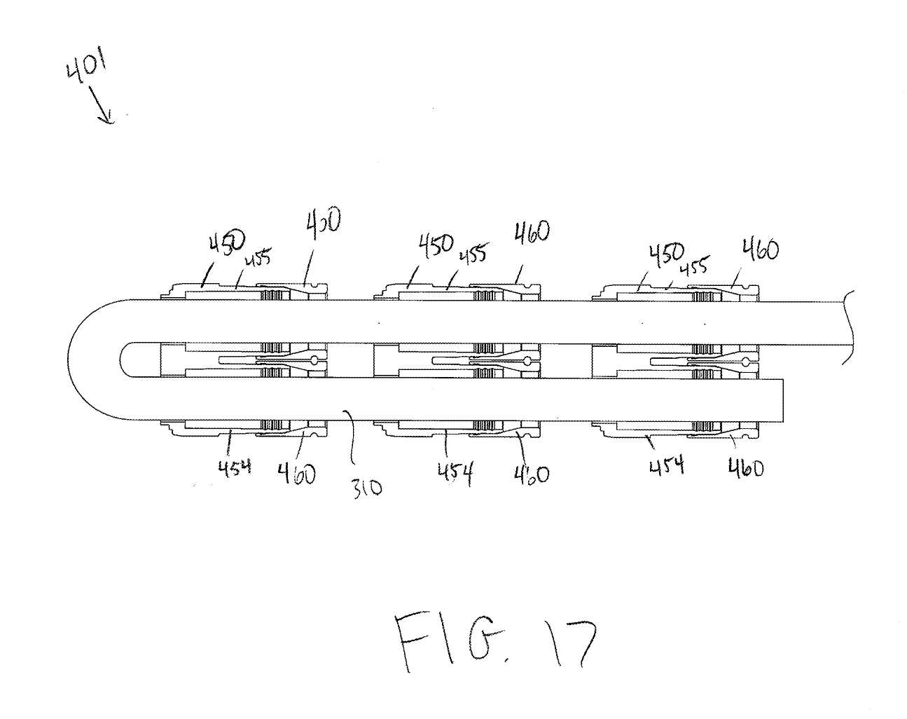

Once the wire 310 has passed through the openings of the fastener members 460 body member 450, a user may axially compress the fastener member 460 to radially compress an end of the first and second body portion 455, 454 of the body member 450 onto the wire 410, which can securely fasten the wire 310 to the body member 450. Accordingly, an end of the wire 310 can be terminated by the wire end termination 400 with various attachment devices. FIGS. 16 and 17 depict an embodiment of wire end termination 401. Embodiments of wire end termination 401 includes a plurality of wire end terminations as described in association with wire end termination 400 on a single length of wire 310.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. A compression terminal comprising:
an electrical terminal member, the electrical terminal member configured to receive a stranded wire having a protective outer jacket surrounding a strand bundle; and
a fastener member including a first inner bore having a first diameter and a second inner bore having a second diameter, the second diameter being less than the first diameter, wherein an internally tapered wall separates the first inner bore from the second inner bore;
wherein, when the fastener member is axially slidably compressed from a first position to a second position, the fastener member is configured to compress a portion of the electrical terminal member against the stranded wire.

2. The compression terminal of claim 1, wherein the electrical terminal includes a post feature for receiving the stranded wire.

3. The compression terminal of claim 1, wherein the electrical terminal has a metal, conductive body.

4. The compression terminal of claim 1, wherein the compression against the stranded wire creates an annular seal around the stranded wire and securely fastens the stranded wire to the electrical terminal member.

5. The compression terminal of claim 1, wherein the compression terminal is provided to a user in a preassembled configuration.

6. The compression terminal of claim 1, wherein the compression terminal is a high amperage compression connector.

7. A compression terminal comprising:
an electrical terminal member, the electrical terminal member including a post feature configured to receive a stranded wire having a protective outer jacket, a conductive braided layer, and a central dielectric core;
an outer body operably attached to the post feature of the electrical terminal member, the outer body having a first end and a second end; and
a fastener member including a first inner bore having a first diameter and a second inner bore having a second diameter, the second diameter being less than the first diameter, wherein an internally tapered wall separates the first inner bore from the second inner bore;
wherein, when the fastener member is axially slidably compressed from a first position to a second position, the fastener member is configured to compress the second end of the outer body onto the stranded wire.

8. The compression terminal of claim 7, wherein the electrical terminal has a metal body.

9. The compression terminal of claim 7, wherein the compression against the stranded wire creates an annular seal around the stranded wire and securely fastens the stranded wire to the electrical terminal member.

10. The compression terminal of claim 7, wherein the compression terminal is provided to a user in a preassembled configuration.

11. The compression terminal of claim 7, wherein the compression terminal is a high amperage compression connector

12. A wire end termination comprising:
a body member having a first end, a second end, and an inner opening extending axially through the body member, the inner opening starting from the second end an terminating a distance from the first end, wherein the inner opening is configured to receive a non-electrical wire; and
a fastener member including a first inner bore having a first diameter and a second inner bore having a second diameter, the second diameter being less than the first diameter, wherein an internally tapered wall separates the first inner bore from the second inner bore;
wherein, when the fastener member is axially compressed from a first position to a second position, the second end of the body member is radially compressed onto the non-electrical wire received within the inner opening of the body member.

13. The wire end termination of claim 12, further comprising an attachment device, the attachment device being operably connected to the body member proximate the first end.

14. The wire end termination of claim 12, wherein the attachment device is one or more hooks, clips, eyelets, straps, loops, bended hook, bended loop, ring, prepared loops, thimble eyes, carabineers, or a combination thereof

15. The wire end termination of claim 12, wherein the non-electrical wire is steel wire rope.

16. A wire end termination comprising:
a body member having a first end, a second end, the body member comprising:
a first body portion having a receiving end proximate the second end of the body member and an inner opening configured to receive a non-electrical wire through the receiving end, and
a second body portion having a receiving end proximate the first end of the body member and an inner opening configured to receive the same non-electrical wire through the receiving end;
a first fastener member operably attached to the receiving end of the first body portion; and
a second fastener member operably attached to the receiving end of the second body portion;
wherein, when the first fastener member is axially compressed in a first direction, the receiving end of the first body portion is radially compressed onto the non-electrical wire received within the inner opening of the first body portion;
wherein, when the second fastener member is axially compressed in a second direction, the receiving end of the second body portion is radially compressed onto the non-electrical wire received within the inner opening of the first body portion.

17. The wire end termination of claim 16, wherein the non-electrical wire is steel wire rope.

18. The wire end termination of claim 16, wherein the first direction and the second direction are at least one of a same direction and a different direction.

19. The wire termination of claim 16, further comprising: an additional body member configured to be positioned on the same non-electrical wire.

20. A method comprising:
providing a body member having a first end, a second end, and an inner opening extending axially through the body member, the inner opening starting from the second end an terminating a distance from the first end, and a fastener member including a first inner bore having a first diameter and a second inner bore having a second diameter, the second diameter being less than the first diameter, wherein an internally tapered wall separates the first inner bore from the second inner bore;
positioning the inner opening of the body member over a portion of a non-electrical wire;
axially compressing the fastener member from a first position to a second position to radially compress the second end of the body member onto the non-electrical wire received within the inner opening of the body member.
